(19) United States
(12) Patent Application Publication
(10) Pub. No.: US 2012/0186418 A1
(43) Pub. Date: Jul. 26, 2012

(54) System for Automatically Adjusting Sound Effects and Method Thereof

(75) Inventors: Hao Chen, Nanjing (CN); Yun-Fei Wei, Nanjing (CN)

(73) Assignees: INVENTEC APPLIANCES (SHANGHAI) CO., LTD., Shanghai (CN); INVENTEC APPLIANCES CORP., NANJING, Nanjing (CN); INVENTEC APPLIANCES CORP., New Taipei City (TW)

(21) Appl. No.: 13/359,161

(22) Filed: Jan. 26, 2012

(30) Foreign Application Priority Data
Jan. 26, 2011 (CN) 201110037047.1

(51) Int. Cl. G10H 1/02

(52) U.S. Cl. 84/626

(57) ABSTRACT

A system for automatically adjusting sound effects and a method thereof. The system includes a communication module, a playing module, an input module for receiving a choice among a plurality of songs made by a user, and a processing module configured to search a storage module for one of sets of sound effects parameters corresponding to the choice made by the user. If the set of sound effects parameters corresponding to the choice made by the user is not found, the processing module is then configured to obtain the set of sound effects parameters from a plurality of servers through a communication module. The playing module is configured to adjust a playing mode according to the set of sound effects parameters found or obtained by the processing module, and to play the song of choice in the playing mode.

### CROSS-REFERENCE TO RELATED APPLICATION

This application claims the benefit of priority to China Patent Application No. 201110037047.1, filed on Jan. 26, 2011, in the State Intellectual Property Office of the People's Republic of China, the disclosure of which is incorporated herein in its entirety by reference.

### BACKGROUND OF THE INVENTION

1. Field of the Invention

The present invention relates to a system for automatically adjusting sound effects and a method thereof, in particular to the system for automatically adjusting sound effects and a method thereof capable of adjusting sound effects parameters automatically according to the type of songs.

2. Description of the Related Art

As music compression technologies (such as the MPEG 2 LAYER 3 standard, MP3) are developed rapidly, music files in a digital format can be compressed into fractions of the original files, while maintaining a relatively high sound quality, so that a large quantity of music files can be stored in storage media, and transmitted and shared with others via the Internet, or may be played by various software and hardware players. Among these players, a multimedia player with the portable feature becomes one of the most popular playing devices nowadays.

In the prior art, the playing mode of each song played by the multimedia player may need to be manually set by a user. With reference to FIG. 1 for a flow chart of setting sound effects according to the prior art, the setting procedure comprises the following main steps: Starting a setup procedure, a user presses a menu key to enter a main menu and uses a first direction key and a second direction key to select a system setting option from the main menu (S11). And then, the user presses the menu key to confirm the system setting option in order to enter a sub-menu of the system setting option (S12). In a list of options of the sub-menu, the user selects a sound effects setting option of an equalizer, and presses the menu key to perform a setup (S13). The user presses the first direction key or the second direction key to browse a previously set playing mode. After selecting a required option, the user presses the menu key to confirm the set option and return to the system setting menu (S14). Finally, the procedure ends. Obviously, the multimedia player cannot switch the playing mode according to the music being played, and the user has to set the playing mode manually. If the user wants to set the sound effect of a song, the user needs to go over the aforementioned procedures repeatedly, thus causing tremendous inconvenience to the user.

In view of the aforementioned drawbacks of the prior art, the present invention provides a system for automatically adjusting sound effects and a method thereof to overcome the drawbacks of the prior art.

### SUMMARY OF THE INVENTION

In view of the aforementioned shortcomings of the prior art, an objective of the present invention is to provide a system for automatically adjusting sound effects and a method thereof to overcome the problem of not being able to automatically adjust sound effects.

To achieve the foregoing objective, the present invention provides a system for automatically adjusting sound effects, comprising a storage module, a communication module, an input module, a processing module, and a playing module. The storage module is configured to store data of a plurality of songs and a plurality of sets of sound effects parameters. The communication module is configured to connect to a plurality of servers through a network. The input module is for receiving a choice among the plurality of songs made by a user. The processing module is configured to search the storage module for one of the sets of sound effects parameters corresponding to the choice made by the user. If the set of sound effects parameters corresponding to the choice made by the user is not found in the storage module, the processing module is then configured to obtain the set of sound effects parameters corresponding to the choice made by the user from the plurality of servers through the communication module. The playing module is configured to adjust a playing mode according to the set of sound effects parameters found or obtained by the processing module, and to play the song of the choice in the playing mode.

In an embodiment, the set of sound effects parameters obtained by the processing module from the plurality of servers through the communication module is stored in the storage module.

In an embodiment, the playing mode is a mode of playing rock music.

In an embodiment, the playing mode is a mode of playing jazz music.

In an embodiment, the playing mode is a mode of playing pop music.

In an embodiment, the playing mode is a mode of playing classical music.

In an embodiment, the set of sound effects parameters comprises data of the musical type of the song of the choice.

In an embodiment, the data of the musical type comprise rock music type data, jazz music type data, pop music type data, or classical music type data.

To achieve the aforementioned objective, the present invention also provides a method of automatically adjusting sound effects, and the method is applicable to an audio playing system comprising a processing module, a playing module, and a storage module for storing data of a plurality of songs and a plurality of sets of sound effects parameters. The method comprises the following steps: connecting the system to a plurality of servers through a network; the system receiving a choice among a plurality of songs made by a user; the processing module searching the storage module for one of the sets of sound effects parameters corresponding to the choice made by the user, and if the set of sound effects parameters corresponding to the choice is not found, obtaining the set of sound effects parameters corresponding to the choice made by the user from the plurality of servers; and the playing module adjusting a playing mode according to the set of sound effects parameters found or obtained by the processing module, for playing the song of the choice in the playing mode.

In summary, the system for automatically adjusting sound effects and a method thereof in accordance with the present invention may have one or more of the following advantages:

(1) The system for automatically adjusting sound effects and a method thereof may automatically adjust to the fitting sound effects of playing these songs in accordance with the style of the songs selected by users to achieve the best music appreciation effect.

(2) The system for automatically adjusting sound effects and a method thereof may adjust the sound effects automatically to overcome the problem that users do not know how to tune to the best sound effect.

### BRIEF DESCRIPTION OF THE DRAWINGS

FIG. 1 is a flow chart of a conventional way of setting sound effects.

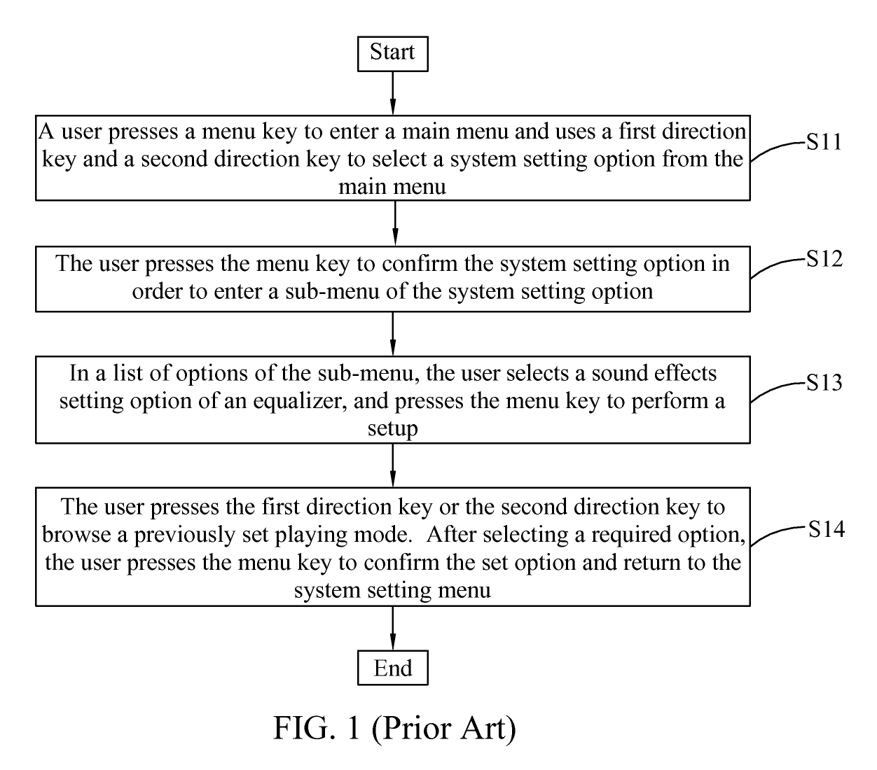

FIG. 2 is a block diagram of a system for automatically adjusting sound effects in accordance with an embodiment of the present invention.

FIG. 3 is a flow chart of steps of a method of automatically adjusting sound effects in accordance with an embodiment of the present invention.

FIG. 4 is a schematic view of a system for automatically adjusting sound effects and a method thereof in accordance with a first embodiment of the present invention.

FIG. 5 is a flow chart of steps of a method for automatically adjusting sound effects in accordance with the first embodiment of the present invention.

FIG. 6 is a schematic view of a system for automatically adjusting sound effects and a method thereof in accordance with a second embodiment of the present invention.

FIG. 7 is a flow chart of steps of a method for automatically adjusting sound effects in accordance with the second embodiment of the present invention.

### DETAILED DESCRIPTION OF THE PREFERRED EMBODIMENTS

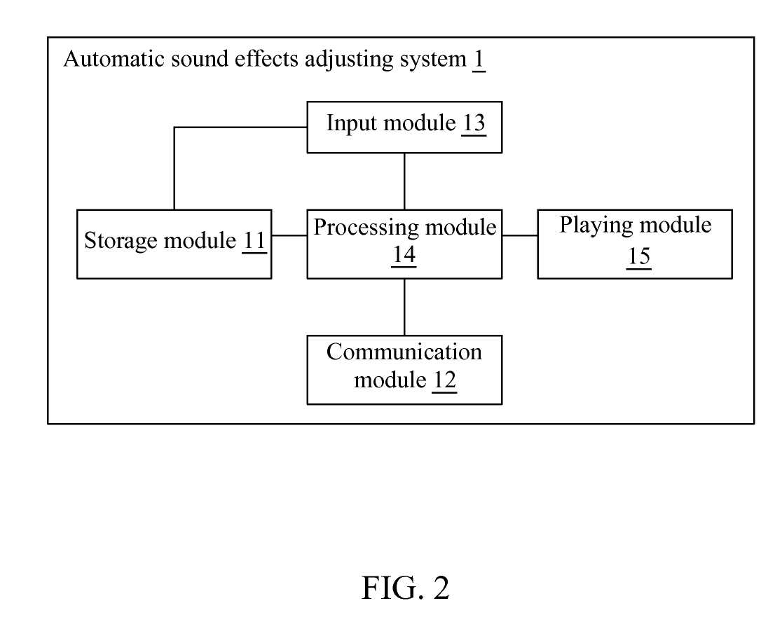

With reference to FIG. 2 for a block diagram of a system for automatically adjusting sound effects in accordance with an embodiment of the present invention, the automatic sound effects adjusting system 1 comprises a storage module 11, a communication module 12, an input module 13, a processing module 14 and a playing module 15. The storage module 11 is provided for storing data of a plurality of songs and a plurality of sets of sound effects parameters. The communication module 12 may be configured to connect to a plurality of servers through a network. The input module 13 is provided for receiving a choice among the plurality of songs made by a user. The processing module 14 is configured to search the storage module 11 for one of the sets of sound effects parameters corresponding to the choice made by the user. If the set of sound effects parameters corresponding to the choice made by the user is not found in the storage module 11, the processing module 14 will obtain the set of sound effects parameters corresponding to the choice made by the user from the plurality of servers through the communication module 12. The playing module 15 is configured to adjust a playing mode according to the set of sound effects parameters found or obtained by the processing module 14, and to play the song of the choice in the playing mode. It's noted that the playing mode may or may not be adjusted before playing the song, and the term “module” used herein means any module, unit, apparatus, or device. It's also noted that the system for automatically adjusting sound effects according to the present invention means, inter alia, any audio playing system, unit, or device for automatically adjusting sound effects of the song of the choice made by the user.

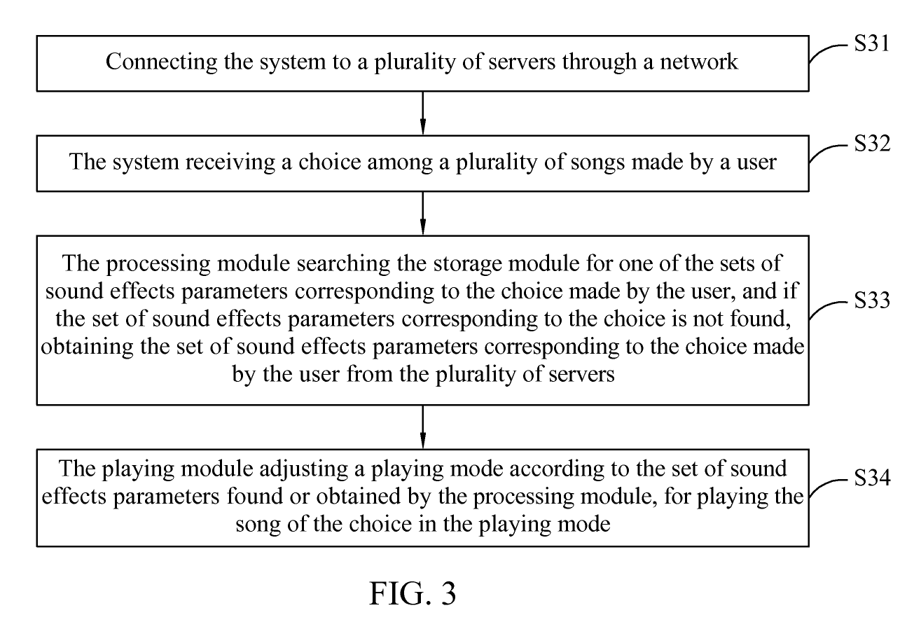

FIG. 3 is a flow chart of steps of a method of automatically adjusting sound effects in accordance with an embodiment of the present invention. The method is applicable to an audio playing system comprising a processing module, a playing module, and a storage module for storing data of a plurality of songs and a plurality of sets of sound effects parameters, and includes the following steps: at S31, connecting the system to a plurality of servers through a network; at S32, the system receiving a choice among a plurality of songs made by a user; at S33, the processing module searching the storage module for one of the sets of sound effects parameters corresponding to the choice made by the user, and if the set of sound effects parameters corresponding to the choice is not found, obtaining the set of sound effects parameters corresponding to the choice made by the user from the plurality of servers; and at S34, the playing module adjusting a playing mode according to the set of sound effects parameters found or obtained by the processing module, for playing the song of the choice in the playing mode. And it's also noted that the audio playing system means, inter alia, any audio playing system, unit, or device for automatically adjusting sound effects of the song of the choice made by the user.

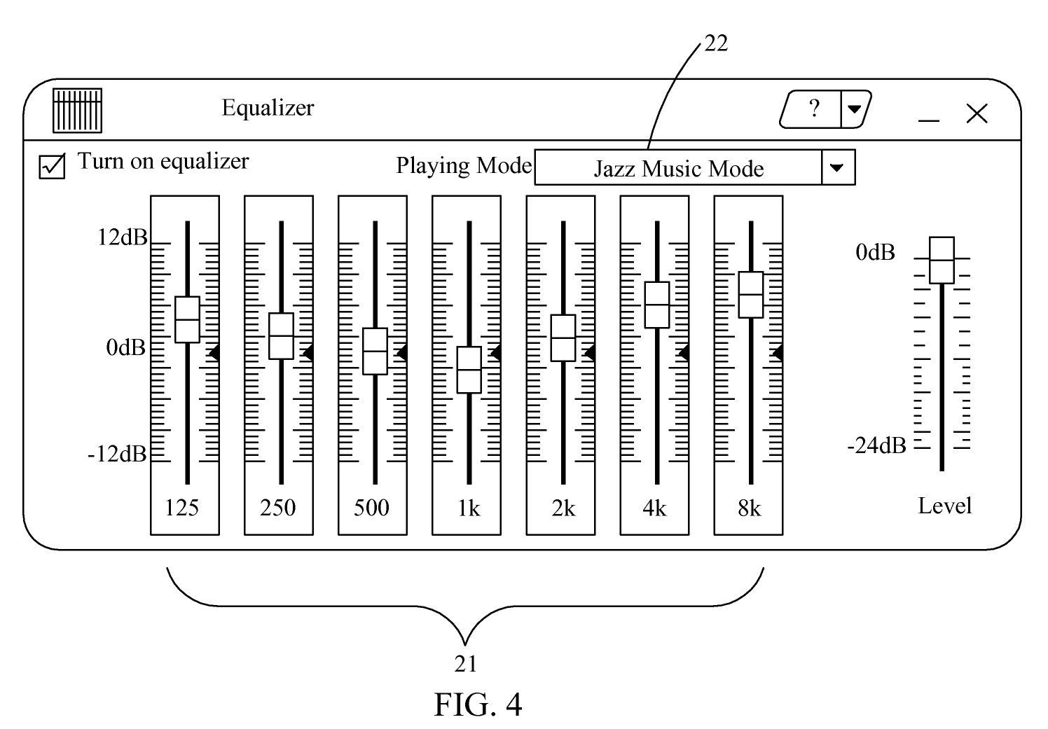

With reference to FIG. 4 for a schematic view of a system for automatically adjusting sound effects and a method thereof in accordance with a first embodiment of the present invention, an equalizer is one of a sound effect processing interface, which is the processing module of the automatic sound effects adjusting system of the present invention. In the embodiment, after a user selects a song of jazz music, the equalizer will automatically search in the system for a set of sound effects parameters 21 suitable for playing jazz music. The playing module will switch to a jazz music mode 22 based on the set of sound effects parameters 21 adjusted by the equalizer, and the song of jazz music selected by the user is therefore played. If the equalizer does not have any suitable set of sound effects parameters 21 in search of the system, the system will connect to a plurality of servers through a network to retrieve a more suitable set of sound effects parameters 21 for playing jazz music by the processing module, and store this set of sound effects parameters 21.

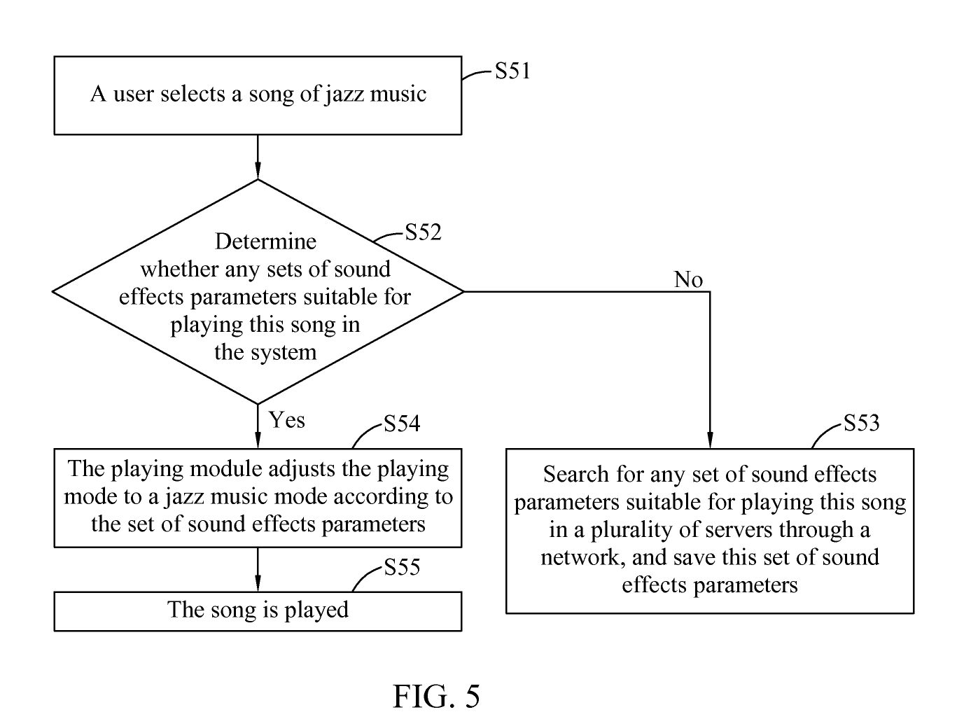

With reference to FIG. 5 for a flow chart of steps of a method for automatically adjusting sound effects in accordance with the first embodiment of the present invention, the method comprises the following steps. S51: A user selects a song of jazz music. S52: Determine whether any sets of sound effects parameters suitable for playing this song is in the system; if yes, go to step S54, if not, go to step S53. S53: Search for any set of sound effects parameters suitable for playing this song in a plurality of servers through a network, and save this set of sound effects parameters. S54: The playing module adjusts the playing mode to a jazz music mode according to the set of sound effects parameters. S55: The song is played.

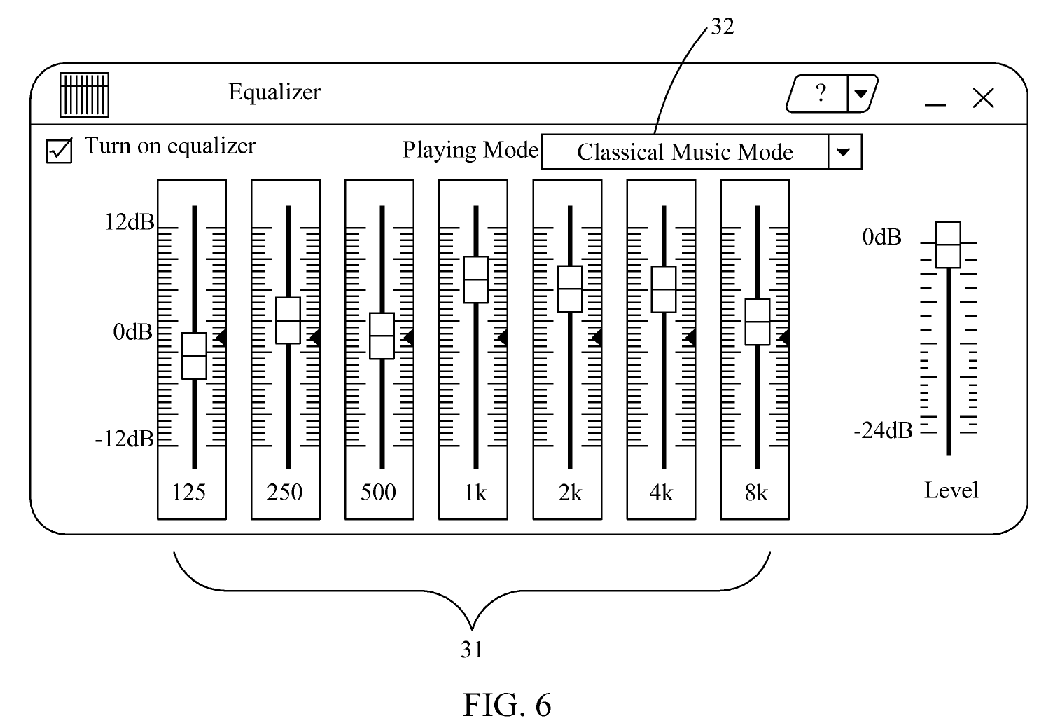

With reference to FIG. 6 for a schematic view of a system for automatically adjusting sound effects and a method thereof in accordance with a second embodiment of the present invention, a user selects a song of classical music. After the user selects a song of classical music, the equalizer will automatically search a set of sound effects parameters 31 suitable for playing the classical music. The playing module will switch to a classical music mode 32 according to the set of sound effects parameters 31 adjusted by the equalizer, and the song of classical music selected by the user is played. If the equalizer does not have any suitable set of sound effects parameters 31 in search of the system, the system will connect to a plurality of servers through a network to retrieve a more suitable set of sound effects parameters 31 for playing classical music by the processing module, and store this set of sound effects parameters 31.

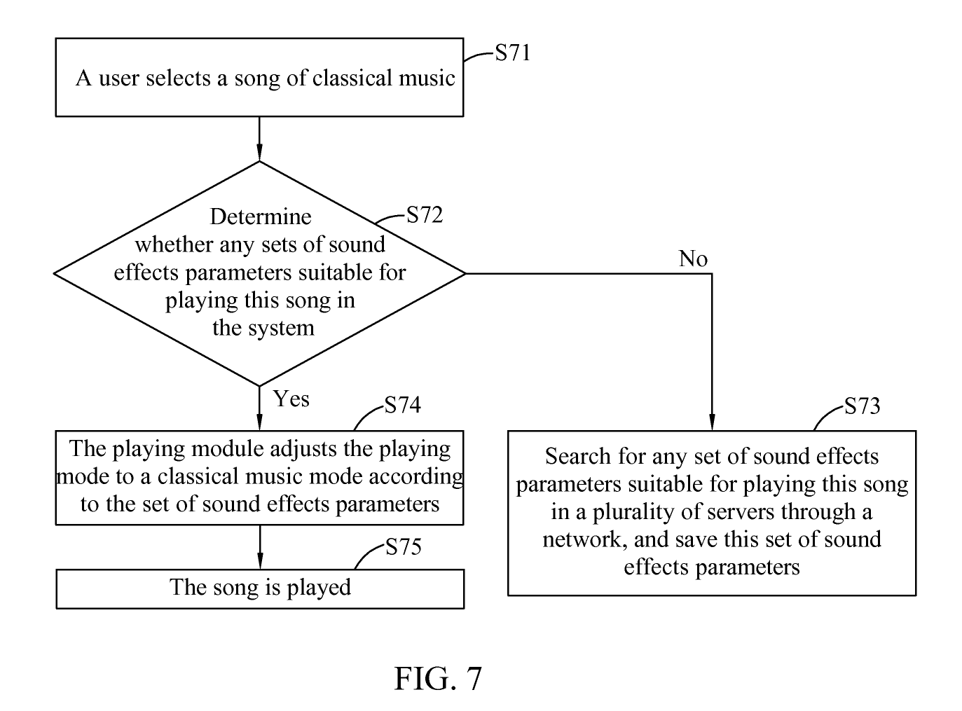

With reference to FIG. 7 for a flow chart of steps of a method for automatically adjusting sound effects in accordance with the second embodiment of the present invention, the method comprises the following steps. S71: A user selects a song of classical music. S72: Determine whether any sets of sound effects parameters suitable for playing this song is in the system; if yes, go to S74, if not, go to S73. S73: Search for any set of sound effects parameters suitable for playing this song in a plurality of servers through a network, and save this set of sound effects parameters. S74: The playing module adjusts the playing mode to a classical music mode according to the set of sound effects parameters. S75: The song is played.

In summary, the automatic sound effects adjusting system of the present invention may overcome the problem that users do not know how to adjust the sound effects, and the system of the invention may adjust the sound effects automatically to achieve the best music appreciation effect.

While the invention has been described by means of specific embodiments, numerous modifications and variations could be made thereto by those skilled in the art without departing from the scope and spirit of the invention set forth in the claims.

What is claimed is:

1. A system for automatically adjusting sound effects, comprising:
a storage module, configured to store data of a plurality of songs and a plurality of sets of sound effects parameters;
a communication module, configured to connect to a plurality of servers through a network;
an input module for receiving a choice among the plurality of songs made by a user;
a processing module, configured to search the storage module for one of the sets of sound effects parameters corresponding to the choice made by the user, wherein if the set of sound effects parameters corresponding to the choice made by the user is not found, the processing module is configured to obtain the set of sound effects parameters corresponding to the choice made by the user from the plurality of servers through the communication module; and
a playing module, configured to adjust a playing mode according to the set of sound effects parameters found or obtained by the processing module, and to play the song of the choice in the playing mode.

2. The system of claim 1, wherein the set of sound effects parameters obtained by the processing module from the plurality of servers through the communication module is stored in the storage module.

3. The system of claim 1, wherein the playing mode is a mode of playing rock music.

4. The system of claim 1, wherein the playing mode is a mode of playing jazz music.

5. The system of claim 1, wherein the playing mode is a mode of playing pop music.

6. The system of claim 1, wherein the playing mode is a mode of playing classical music.

7. The system of claim 1, wherein the set of sound effects parameters comprises data of a musical type of the song of the choice.

8. The system of claim 7, wherein the data of the musical type comprise rock music type data, jazz music type data, pop music type data, or classical music type data.

9. A method of automatically adjusting sound effects, applicable to an audio playing system comprising a processing module, a playing module, and a storage module for storing data of a plurality of songs and a plurality of sets of sound effects parameters, the method comprising the following steps of:
connecting the system to a plurality of servers through a network;
the system receiving a choice among a plurality of songs made by a user;
the processing module searching the storage module for one of the sets of sound effects parameters corresponding to the choice made by the user, and if the set of sound effects parameters corresponding to the choice is not found, obtaining the set of sound effects parameters corresponding to the choice made by the user from the plurality of servers; and
the playing module adjusting a playing mode according to the set of sound effects parameters found or obtained by the processing module, for playing the song of the choice in the playing mode.

10. The method of claim 9, further comprising storing the set of sound effects parameters obtained by the processing module from the plurality of servers into the storage module.

11. The method of claim 9, wherein the playing mode is a mode of playing rock music.

12. The method of claim 9, wherein the playing mode is a mode of playing jazz music.

13. The method of claim 9, wherein the playing mode is a mode of playing pop music.

14. The method of claim 9, wherein the playing mode is a mode of playing classical music.

15. The method of claim 9, wherein the set of sound effects parameters comprises data of a musical type of the song of the choice.

16. The method of claim 15, wherein the data of the musical type comprise rock music type data, jazz music type data, pop music type data, or classical music type data.
